(19) United States
(12) Patent Application Publication
(10) Pub. No.: US 2015/0314989 A1
(43) Pub. Date: Nov. 5, 2015

(54) Material Lift Hoist Assembly

(71) Applicant: Achille Bruno, Brooklyn, NY (US)

(72) Inventor: Achille Bruno, Brooklyn, NY (US)

(21) Appl. No.: 14/266,778

(22) Filed: Apr. 30, 2014

(51) Int. Cl. B66B 9/16

(52) U.S. Cl. CPC B66B 9/16

(57) ABSTRACT

The present invention provides a safe, self-supporting, and a secure material lift assembly. The material lift assembly comprises a hollow central pole having a track for raising a load bearing platform on the track. The track is connected to a cable running inside the central pole having its one end connected to a motor and the second end connected to the track. The load bearing platform is attached to the central poles through a hinge assembly having a plurality of hinge parts and pins preventing the lateral movement of the platform when the hinge assembly is connected through pins and allowing the swivel movement of the platform when the pins are removed. The load-bearing platform is tiltable in three different directions and may swing inside a building facilitating safe and convenient material transport.

### FIELD OF THE INVENTION

The present invention relates to a material lift hoist assembly, more particularly, to a self-supporting material lift assembly.

### BACKGROUND

A Material Lift is a type of vertical transport that is used for efficiently moving goods between floors of a building. Lifts are generally powered by electric motors that either drive traction cables or counterweight systems like a hoist. Various devices have been developed for the lifting or other movement of relatively large and bulky articles.

Material lifts are in common use. However, these material lifts suffer from serious limitations. The conventional material lifts are bulky and unsecure and their use is limited by the large space they need in order to be placed. The conventional lifts can effectively serve only a single floor and may require pull cables. Furthermore, these material lifts do not swivel and hence require additional machinery such as a forklift to operate it. While using conventional material lifts, the weight imbalance strains the scaffold so that the lift gets stuck on both the way up and down. These limitations make traditional material lifts dangerous to operate. Therefore, there is a need to provide a material lift assembly that is secure, safe, and self-supporting.

In view of the aforementioned limitations, the present invention provides a secure, safe, self-supporting material lift hoist assembly. The material lift of the present invention can be used for buildings with delicate roofs such as roofs with Spanish tiles, without requiring pull cables for operation of the material lift. The material lift is very effective for a 4 to 5 story building and is expandable to any height desired.

### BRIEF SUMMARY OF THE INVENTION

The present invention provides a self-supporting and a secure material lift assembly. The lift assembly uses a foundation on the ground in the form of a post or a base plate stabilizer that has fastening means for securing the assembly to the ground. A hollow pole is mounted on the post or base plate stabilizers having a self-recessed coupling portion at one end of the said pole. The pole is hollow on the inside and provides a way to a cable; the cable is connected to a motor at its first end and a track on the other end. The track is attached to and runs along the said pole's exterior. A load bearing pivotable and removable platform is attached to and runs along the said track. The track stabilizes the platform and prevents lateral platform movement as the cable is moved by the motor. The cable is connected to the said track on the interior of the pole and allows the load bearing platform to be moveable and stoppable along the vertical axis of said pole. A box is attached to the load bearing platform by a three way hinge mechanism that allows a person to tilt the box inside the building through a window, door or other opening. The box can be moved laterally to the left and right to allow for loading and unloading of the material inside of, outside of, or on top of said building.

A plurality of scaffolding supports are attached to the pole, each of the plurality of scaffolding support extends horizontally from said pole and connects to building openings of an outside façade of a building exterior. The scaffolding supports connect to frame posts that fit inside the window frame of a building's exterior; said scaffolding supports are fastened to the frame posts at the ends of said frame posts. A plurality of hinges and pins arranged in a quadrilateral orientation are connected to the load bearing platform that stabilizes the load bearing platform from horizontal rotational movement around the pole when said pins are fitted into said hinges and allow for such rotational swivel movement when said pins are removed. The entirety of the material lift hoist assembly is set up on said building's exterior with a remote control means for operating the motor to raise and lower the platform.

### BRIEF DESCRIPTION OF THE DRAWINGS

The preferred embodiment of the invention will hereinafter be described in conjunction with the appended drawings provided to illustrate and not to limit the scope of the invention, wherein like designation denotes like element and in which:

FIG. 1 is an exploded view of a material lift assembly, showing various components that are assembled to form the material lift assembly.

FIG. 2 shows a side plan view of a pole used in material lift assembly.

FIG. 3 shows a pole rider that fits on the pole and travels along the track on the pole.

FIG. 4A shows the side hinge.

FIG. 4B shows the front hinge that is connected to the pole rider.

FIG. 5 shows a bottom plan view of a load bearing platform.

### DETAILED DESCRIPTION OF THE EMBODIMENTS

In the following detailed description of embodiments of the invention, numerous specific details are set forth in order to provide a thorough understanding of an embodiment of the invention. However, a person skilled in the art may recognize that the embodiments of the invention may be practiced with or without these specific details. In other instances well known methods, procedures and components have not been described in details so as not to unnecessarily obscure aspects of the embodiments of the invention. Furthermore, it will be clear that the invention is not limited to just these embodiments. Numerous modifications, changes, variations, substitutions and equivalents will be apparent to those skilled in the art, without departing from the spirit and scope of the invention.

The present invention provides a self-supporting material lift hoist assembly that uses a post on the ground exterior to the building in the form of large base plates. The base plates are secured to the ground using a securing means. A hollow pole is mounted at the center of the base plates. The hollow pole contains a self-recessed coupling portion that allows two hollows poles to fit into each other. A track is provided in the form of a pole rider that is attached to and runs along the said pole's exterior. A cable runs across the center of the hollow pipe that is connected to a motor at first end and to the pole rider at the second end. The placement of the motor relative to the central pole is flexible and independent of the operation of the invention. The motor rotates in clockwise and counter clockwise directions to wind or unwind the cable. As the motor rotates, it winds or unwinds the cable on the pulley. Since the other end of the cable is connected to the pole rider, as the cable winds or unwinds, the pole rider moves upward or downward in the vertical direction. A load bearing platform is attached to the pole rider such that as the pole rider moves in the vertical direction, the platform also moves along with it. The load bearing platform is attached to the pole through a plurality of hinges and pins arranged in a quadrilateral orientation, such that when the pins are put in the hinges, the structure is fixed and lateral movement of the load bearing platform is prevented. The hinge stabilizes the load-bearing platform from horizontal rotational movement around the pole when said pins are fitted into said hinges. When the pins are removed from the hinges, it allows the rotational swivel movement. The motor is controlled remotely so as to allow the load-bearing platform to be moveable and stoppable along the vertical axis of the pole.

A box is attached to the said load bearing platform by a three way hinge mechanism that allows a person to tilt said box inside the building through a window, door, or other building openings, and laterally to the left and right to allow for loading and unloading of material inside of, outside of, or on top of said building. The pole is attached with a plurality of scaffolding supports that extends horizontally from said pole and connects to building openings of an outside façade of a building's exterior. The scaffolding supports connect to a frame post that fits inside the window frame of a building's exterior. The scaffolding supports are fastened to the frame posts at the ends of said frame posts. The entirety of the material lift hoist assembly is set up on said building's exterior with a remote control means for operating the motor to raise and lower the platform.

The material lift assembly can be positioned up to three inches from a multistory building façade and thus the central hollow pole can be positioned up to 3 inches next to a building's façade. The material lift assembly is designed for use with a three to four story building exterior. The material lift assembly assembled by this method has a carrying capacity of 600 pounds. The assembly can fit even in a small area measuring 3×3 square feet.

In embodiments of the present invention, the box may be rotated about a central axis and also tilted about two axes to facilitate unloading into building openings such as windows or other access points.

In embodiments of the present invention an axis of rotation around the central pole is created by a three panel hinge attached to (i) the sleeve (“pole rider”) which carries the box base up and down the central pole, preferably having wheels that ride upon said central pole, and (ii) to the box base. This may be, for example, a hinge mechanism that allows the platform to rotate around the width of the pole. If a pin of the hinge on the right side of the platform is removed it allows the platform to rotate 180 degrees to the left. If a pin of the hinge on the left side of the platform is removed, then the platform can be rotated 180 degrees to the right.

For the first axis allowing tilt, for example, a box base may be affixed to a rotatable mechanism, such as a pole with stops, allowing the box base and its box to tilt to the left and right of the central pole. A box for carrying material may be affixed to the box base thus allowing the box and box base to tilt to the left and right upon an axis perpendicular to the central pole upon which it rides up and down.

Further, the box itself may have a hinge which attaches the box to the box base, said hinge allowing for forward tilting of the box about an axis parallel to one or more planes of the central pole. For example, a second hinge mechanism in the box allows the box attached to the load bearing platform (“box base”) to tilt the box forwards from the central pole and which box has a locking pin, preventing unwanted tilting.

Thus, the box itself or box and box base can be manipulated in several directions from the central pole, (i) rotating about the central pole, (ii) tilting towards the right of the central pole and towards the left of the central pole, or (iii) tilting away from the pole.

The present invention also provides an advantage in that the weight of the load bearing platform is on a central pole and not on a scaffold.

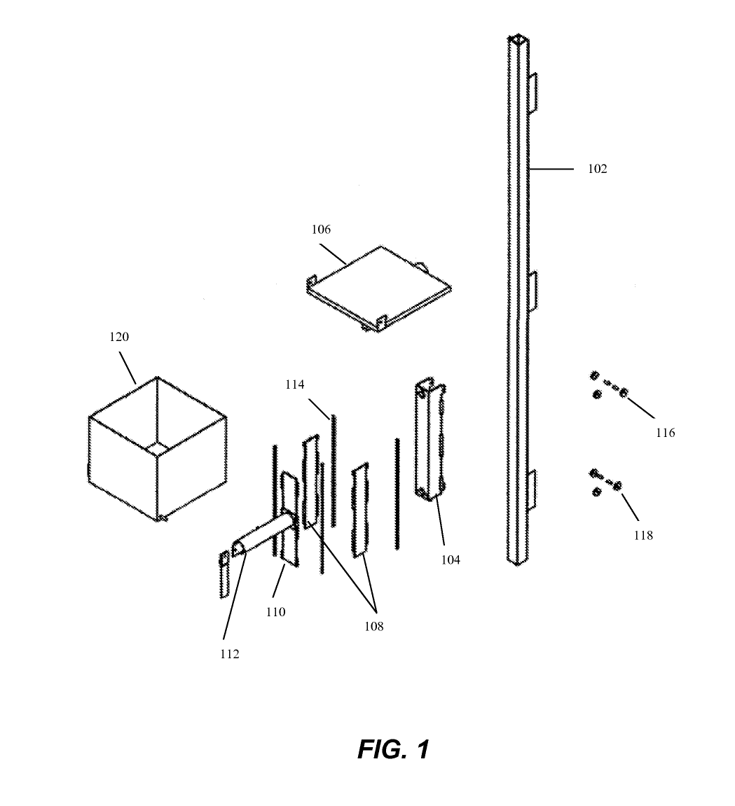

Referring now to FIG. 1, it is an exploded view of a material lift assembly, showing various components that are assembled to form the material lift assembly. The component of the material lift assembly consists of a central pole 102 mounted on the base platform. The pole 102 is 10-12 feet in length, each pole has a self-recessed coupling portion at both ends such that one pole can be fit into the second pole. The pole 102 can be fit within other poles such that four to five poles can be self-coupled to increase the height of the material lift to between forty and fifty feet, spanning four to five stories of the building. A pole rider 104 performs the function of providing a track for the lift. The pole rider 104 rides over the pole 102 to provide the vertical movement. The vertical movement of the pole rider 104 is provided by a cable that is connected to the motor at one end and to the pole rider at the second end. A platform 106 is attached to the pole rider 104 such that as the pole rider moves over the pole 102, the platform 106 also moves in the vertical direction. The platform 106 carries the load from one floor to another. A plurality of hinges is provided that are arranged in a quadrilateral manner with the pole rider. The plurality of hinges comprises two side hinges 108 and a front hinge 110. The front hinge 110 has a shaft 112 that extends from the center of front hinge 110 in the outward direction. The shaft 112 at the distal end has a means to insert a handle. The front hinge 110, both the side hinge 108 and the pole rider 104 are locked together by using a plurality of pins 114. The side hinges 108 are locked to the pole rider 104 at first side and with the front hinge 110 at the second side using four pins 114, thus forming a quadrilateral orientation.

A plurality of wheels 116 is provided that fits into the interior of the pole rider 104. The wheels 116 aid in the rolling of pole rider 104 over the pole 102. When the cable is pulled in the vertical direction, the pole rider 104 attached to the cable also moves and the movement over the pole 102 is provided by the wheels 116 located in the interior of the pole rider 104. The plurality of wheels 116 are placed in a plurality of wheel holders 118 that allow the wheels 116 to remain in fixed position.

The platform 106 is a square size structure and at the bottom side the platform has a hollow shaft on a horizontal axis, through which the shaft 112 of the front hinge passes. The platform 106 is pivotally attached to the pole rider 104 through the front hinge shaft 112. A handle can be inserted in the front hinge shaft 112 for rotation around the pole axis. The platform 106 can be rotated around the pole horizontal axis by removing one pin 114 connecting the side hinge 108 with the front hinge 110. If the pin that is removed from the hinge is on the left side, then the platform 106 can be rotated to the right at an angle of 180°. If the pin is removed from the right side, then the platform can be rotated to the left by 180°. Thus the material lift assembly provides a rotation of 360° around the platform. A box 120 can be attached on the platform 106 having a three way hinge mechanism. The box 120 provides a flat surface and safe transport for the material as wind does not swing or cause material to spill. The three way hinge mechanism allows the box 120 to tilt in three directions; namely, opposite of the pole, to the left of the pole and to the right of the pole. The box can be made of steel, fiberglass or plastic.

To affix the lift assembly in place, the pole 102 at the ground is supported by a large base plate, which is grouted at the ground through securing means. At the upper end, the pole can be supported by a scaffold support that extends horizontally from the pole to the exterior of the building façade. A frame post fits into the window frame of the building's exterior. The horizontal scaffolding support from the pole is connected to the frame post.

The material lift of the present invention is self supporting; having its weight on the central pole and not on the scaffold. The lift travels on a track with the cable running inside the pole. The lift is ideal for small story structures such as 4 to 5 story buildings. The central pole can be extended above the roof to bring the platform there. The pole is connected to itself by coupling the pole with another pole as each pole contains a self-recessed portion for coupling. One advantage of the material lift assembly is that the motor location is independent of and can be placed at any location. The motor need not be located on the roof top. Further, the material lift of the present invention does not require traditional scaffolds and thus can be used even for buildings with delicate roofs like Spanish tile roofs. The hinge structure prevents the lateral movement of the platform as the maximum lateral movement of the cable is less than ¼^{th} of an inch. Using the cable-motor mechanism, the platform can be stopped on any floor and no cable pulley is needed.

In one embodiment, the platform can travel to the surface below street level if the pole is set up below street level and can reach the upper roof level up to where the pole is extended. The box can be dumped on three sides, on the left and right, by a mechanical arm.

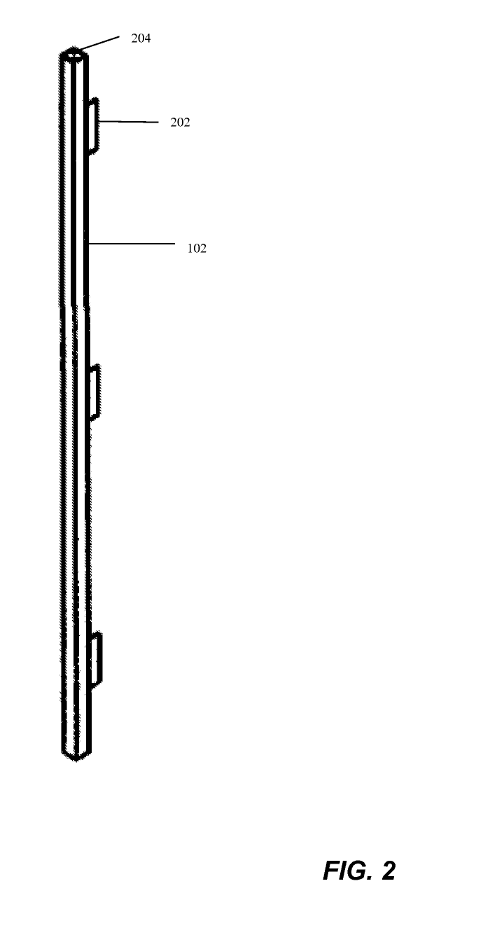

FIG. 2 shows a side plan view of a pole used in the material lift assembly. The pole 102 is rectangular or circular in shape having a plurality of means 202 for providing scaffolding support to the pole. The plurality of scaffolding supports 202 extend horizontally from the pole and connect to a building opening of an outside façade of a building exterior. The scaffolding supports connect to frame posts that fit inside the window frame of a building's exterior and are fastened to the frame posts at the ends of said frame posts. The pole at one end contains a self-recessed coupling 204 so as to allow the second pole to fit in the pole. In this manner by connecting a plurality of poles, the height of the lift assembly can be extended to the desired level. The base pole is connected to the ground by an attachment to a large base plate.

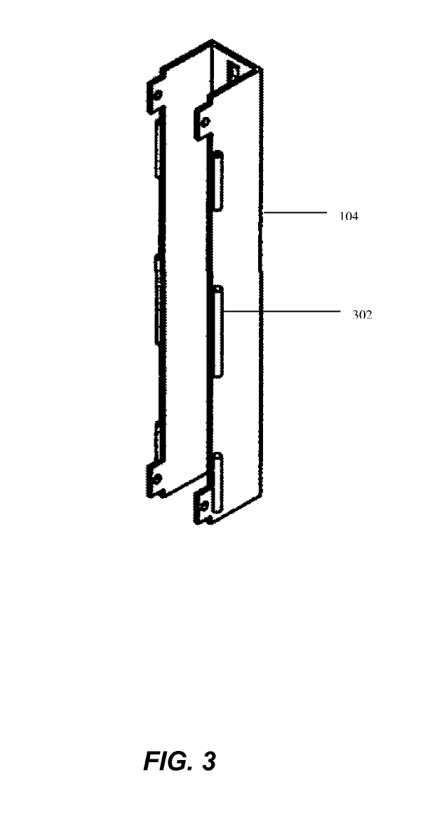

FIG. 3 shows a pole rider 104 that fits on the pole 102 and travels along the track on the pole. The pole rider 104 is U-shaped having three sides that fit the three sides on the pole. The pole rider 104 has wheel 116 located on the wheel holder. The cable coming from inside of the hollow pole is attached to the pole rider. The wheels located inside the pole rider allow the pole rider to slide over the pole as the cable moves upward/downward. The ends of U-shaped pole rider contain housing 302 for pins such that when a side hinge 108 is placed adjacent to the pole rider 104, it can be locked with the pole rider using the pins.

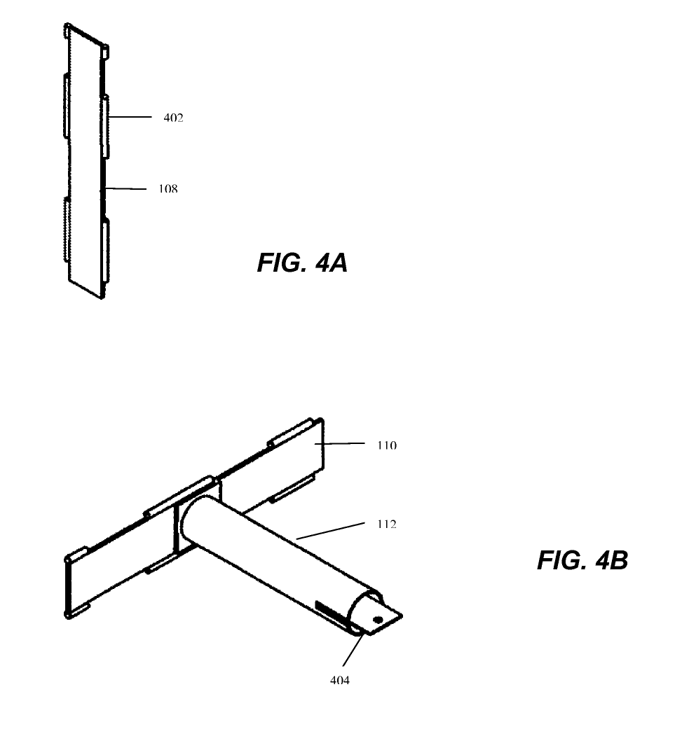

FIG. 4A shows the side hinge and FIG. 4B shows the front hinge. The side hinge 108 is a flat rectangular sheet structure having dimensions preferably with a length equal to the pole rider 104 length and preferably having width sufficient to span the one side of the pole 102. On both the sides of the side hinge, a plurality of hollow protrusions 402 is present that fits with the protrusions on the pole rider 104 and the front hinge. A pin can be inserted in the hollow protrusions 402 for locking the side hinge 108 with the front hinge 110 and the pole rider 104. FIG. 4B shows the front hinge. The front hinge 110 is similar in dimensions to the side hinge. A shaft 112 is extended from the center of the front hinge 110 in the lateral direction extending horizontally from the axis of the front hinge 110. At the end of the shaft 112 a means 404 for fixing a handle is provided. The front hinge 110, both the side hinges 108 and the pole rider 104 attach and lock with each other by putting the pins 114 in the protrusions, resulting in a quadrilateral structure around the pole. The quadrilateral structure formed by the front, side hinges and the pole rider can be rotated around the pole by removing one pin connecting a side hinge and the front hinge, and rotating using the handle structure in the opposite direction.

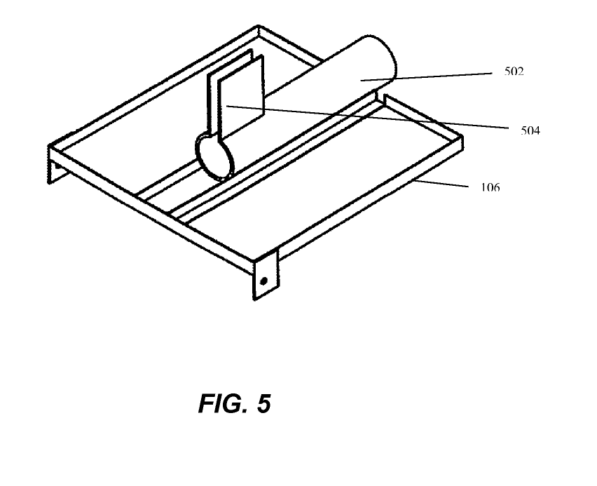

FIG. 5 shows a bottom plan view of a load bearing platform. The load bearing platform 106 is removably attached to the pole through the quadrilateral structure. The platform 106 is square or rectangular in shape and the size depends on the amount of load the user wishes to transport. At the bottom the platform 106 has a hollow shaft 502 that runs through the center of the platform 106. The shaft 112 of the front hinge 110 extends through the hollow shaft 502 located on the bottom of the platform 106. The hollow shaft 502 has an extension 504 emerging laterally from the hollow shaft so as to provide a passage to the handle of the front hinge shaft 112. The platform 106 can be rotated in either the left or the right direction by rotating the shaft 112 of the front hinge 110. The platform can be rotated in either the left or right direction by removing the pin from the right side hinge or the left side hinge and rotating the shaft using the handle. The box provided on the platform with a three way hinge mechanism allows dumping the material inside the building while the platform stays attached to the lift. The box can be dumped on three sides, in, left and right through the use of a mechanical arm.

We claim:

1. A material lift hoist assembly comprising:
a pole having a movable sleeve which rides upon the pole,
the sleeve having at least two attachment points for a hinge assembly and at least one cylindrical member extending from the sleeve and substantially perpendicular to the pole;
a base having a tube disposed on its lower side and substantially surrounding said cylindrical member and having flanges into which at least two pins are removably inserted and having an attachment point for one face of the hinge assembly;
a container resting upon said base and having holes into which at least two pins may be removably inserted;
wherein said hinge assembly comprises at least three faces and at least two removable hinge pins.

2. A material lift hoist assembly comprising:
a base plate having securing means for securing to the ground outside a building; a hollow pole comprised of self-coupling parts, said hollow pole, mounted on said base plate with a cable running through the hollow pole, one end of the cable is connected to a motor and the second end of the cable is connected to a track that is attached to and runs along the said hollow pole's exterior;
a scaffolding arrangement extending from said pole; a load bearing tiltable, pivotable, rotatable, removable platform attached to the track through a hinge assembly consists of a plurality of hinge parts and pins arranged in a quadrilateral orientation; said platform capable of being moved inside said building; said cable driven by the motor is being movably connected to said track on the interior of the hollow pole; said motor being located away from the rest of the material lift hoist assembly; said assembly capable of elevating and lowering said platform along the entire height of said building.

3. The material lift hoist assembly of claim 2 wherein a box is removably attached to the load bearing platform by a three way mechanism.

4. The material lift hoist assembly of claim 3 wherein said load bearing platform is tiltable in three directions, away form said pole, towards the right of said pole and towards the left of said pole.

5. The material lift hoist assembly of claim 2 wherein the track stabilizes the load bearing platform and prevents lateral platform movement as the cable is moved by the motor.

6. The material lift hoist assembly of claim 2 wherein the platform is moveable and stoppable along the vertical axis of the hollow pole.

7. The material lift hoist assembly of claim 2 wherein the hinge assembly comprises the outer side of a pole rider, two side hinge parts and one front hinge part with a shaft that extends horizontally from the center of the front hinge part.

8. The material lift hoist assembly of claim 2 wherein the hinge assembly is formed by arranging the plurality of hinge parts in a quadrilateral manner and coupling the said hinge parts by inserting pins.

9. The material lift hoist assembly of claim 2 wherein the hinge assembly prevents the load bearing platform from horizontal rotational movement around the pole when said pins are fitted into said hinges and allow for such rotational swivel movement when said pins are removed.

10. The material lift hoist assembly of claim 7 wherein the shaft on the front hinge has an attachment means to swivel the hinge assembly.

11. The material lift hoist assembly of claim 2 wherein the load bearing platform can rotate around the central axis of the pole by removing a hinge pin on the right side, allowing the platform to rotate 180 degrees to the left.

12. The material lift hoist assembly of claim 2 wherein the load-bearing platform can rotate around the center axis of the pole by removing a hinge on the left side, allowing the platform to rotate 180 degrees to the right.

13. The material lift hoist assembly of claim 2 wherein the load bearing platform may be delivered to multiple floors of the building by running along said track without additional disassembly and reassembly.

14. The material lift hoist assembly of claim 2 wherein the hollow pole is attached with a plurality of scaffolding supports that extends from said pole and connects to the building exterior.

15. The material lift hoist assembly of claim 2 wherein the height of the material lift assembly can be increased by coupling the hollow poles through self-recessed coupling means on the poles.

16. The material lift hoist assembly of claim 2 wherein the motor location is independent of the working of the material lift assembly and the motor is controlled through a remote control means.

17. The material lift hoist assembly of claim 2 wherein the load bearing platform may swing inside the building through a window to allow unloading of material inside the building.
